(19) United States
(12) Patent Application Publication
(10) Pub. No.: US 2003/0197091 A1
(43) Pub. Date: Oct. 23, 2003

(54) Aircraft fuselage lift arrangement

(76) Inventor: Manuel Munoz Saiz, Almeria (ES)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/447,398

(22) Filed: May 29, 2003

Related U.S. Application Data
(63) Continuation-in-part of application No. 09/907,995, filed on Jul. 18, 2001.

(30) Foreign Application Priority Data
Feb. 27, 2001 (ES) P200100457

(51) Int. Cl. B64C 1/00; B64C 3/00

(52) U.S. Cl. 244/36

(57) ABSTRACT

The present invention is direct to an aircraft fuselage lift arrangement which includes an elongated vertically flattened oval cross section fuselage having a longitudinal axis; an upper longitudinal axis along the upper most portion of the fuselage and parallel to the longitudinal axis, a lower longitudinal axis parallel to the longitudinal axis and along the length of the bottom of the fuselage. The fuselage having a conical nose portion at one end and a conical tail portion at its opposite end. The nose portion of the fuselage having an upwardly inclined front wall extending upwardly from the bottom of the fuselage to at least the upper longitudinal axis of the fuselage. The tail portion of the fuselage having a downwardly declining rear wall extending from the upper longitudinal axis to the bottom of the fuselage. The fuselage also having a main landing gear.

### CROSS REFERENCE TO RELATED APPLICATIONS

This application is a continuation-in-part of U.S. patent application Ser. No. 09/907,995, filed on Jul. 18, 2001, entitled AIRCRAFT FUSELAGE LIFT ARRANGEMENT, which claims the priority date of Spanish Patent P200100457 filed on Feb. 27, 2001. The basis for priority in this case is the Paris Convention for the Protection of Industrial Property (613 O.G. 23. 53 Stat 1748). The Spanish patent application was filed in the Official Patent and Trademark Office of Spain.

### BACKGROUND OF THE INVENTION

1. Field of the Invention

On aircraft fuselages.

2. State of the Prior Art

Existing aircraft fuselages have a front and/or rear layout in some cases which is conical or similar to deflect the air radially without any way taking advantage of slipstream energy.

### DESCRIPTION OF THE INVENTION

The aircraft fuselage lift arrangement refers to elongated constant central cross section fuselages and consists of setting the aircraft fuselage nose in an upward inclination with a conical shape or with a flat wall on the bottom which, running from the underside of the fuselage, is inclined forward until meeting its upper zone; said inclined wall exploits the frontal incident air top create major lift and, because of the angle which it forms, frontal resistance is the same as that of a conventional aircraft fuselage; the tail is inclined downward with a conical shape or with a flat wall in the upper part running from the top of the fuselage and slope backwards as far as its bottom area, to exploit the suction of the rear air to create major lift and, because of its angle, the tail resistance is the same that of a conventional aircraft.

The oblique cones at the nose and tail are linked around their bases to the fuselage and inclined so that their more external generatrixes of said cones are in line with and form a continuation of said upper and lower longitudinal axis of said fuselage and whose cross-section is oval, vertically flattened, laterally flattened, as well can adopt a curved or semicircular upper surface and a lower one flattened or vice versa, with the linkage rounded. In this way it is obtain lift bigger or smaller respectively than the one obtained with a circular cross-section.

The inclination degree of the nose and tail, and their bigger or smaller vertical flattened or lateral enlargement of the same, can be calculated so that at cruise speeds or of more length, the nose weight be equal to the lift, being necessary to counteract the weight at low speeds by means of a slight inclination of the fuselage or using small fins or wings.

The fuselage can adopt a cross-section equal to the nose or tail base or in the case of being different they have to be joined or linked by means of a smooth streamlined union or joint.

The fuselage can be slightly curved lengthways with its concavity in the bottom.

A small portion of the nose and tail tips can be slightly curved downwards and upwards respectively.

The nose lower surface or the tail upper surface can be slightly curved or convex respectively, for both conic and flat noses or tails.

The nose and the tail or a portion of the same can be rotary or swinging at their bases and around an axis parallel to the transversal aircraft axis.

Only are necessary complementary small lifting wings, stabilizing fins or it can be enough with the tail stabilizer.

The total drag is smaller than the drag produced with aircraft wings.

Drawings do not show the engines, wings and flight controls fins.

### BRIEF DESCRIPTION OF THE DRAWINGS

FIG. 1 shows a side schematic view of the fuselage of the invention.

FIG. 2 shows schematic cross section view of a fuselage with the lift arrangement of the invention.

FIG. 3 shows schematic cross section view of a fuselage with the lift arrangement of the invention.

FIG. 4 shows schematic cross section view of a fuselage with the lift arrangement of the invention.

FIG. 5 shows schematic cross section view of a fuselage with the lift arrangement of the invention.

FIG. 6 shows schematic cross section view of a fuselage with the lift arrangement of the invention.

FIG. 7 shows a schematic side view of a fuselage with the lift arrangement of the invention.

FIG. 8 shows a schematic side view of a fuselage with the lift arrangement of the invention.

FIG. 9 shows schematic cross section view of a fuselage with the lift arrangement of the invention.

FIG. 10 shows a schematic side view of a fuselage with the lift arrangement of the invention.

FIG. 11 shows a schematic side view of a fuselage with the lift arrangement of the invention.

FIG. 12 shows a lateral partial schematic view of a nose.

FIG. 13 shows a lateral partial schematic view of a tail.

### DETAILED DESCRIPTION OF THE INVENTION

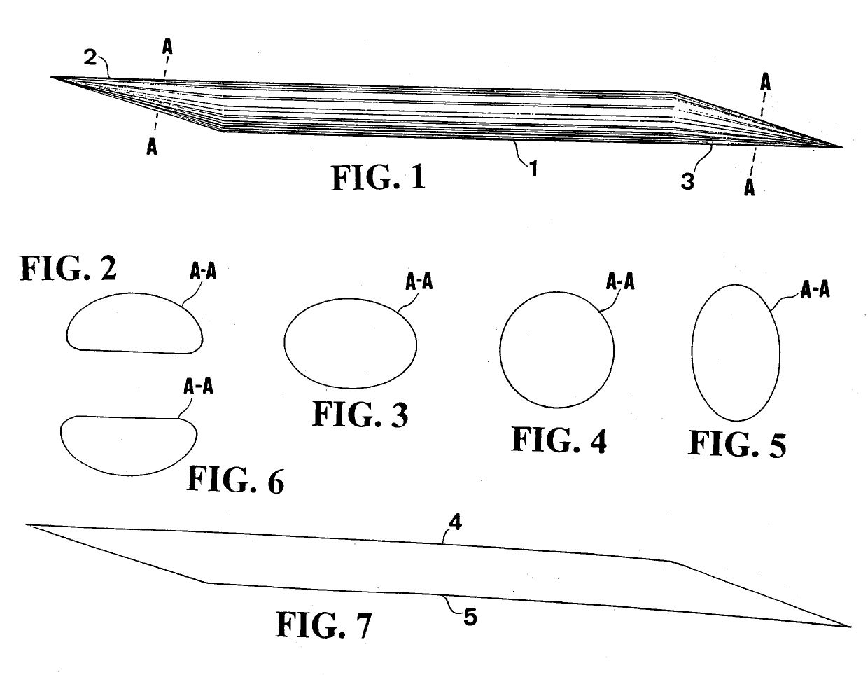

FIG. 1 shows the central fuselage (1), the conical nose (2), the conical tail (3) and the cross-sections of the same (A-A).

FIG. 2 shows the cross-section (A-A) which produces high lift in the nose.

FIG. 3 shows the cross-section (A-A) in the nose or in the tail, which is oval and vertically flattened, which produces more lift than the circular type.

FIG. 4 shows the cross-section (A-A) of the circular type, related with patent P9601904.

FIG. 5 shows the cross-section (A-A) in the nose or in the tail, which is oval and laterally flattened, it produces the lowest lift.

FIG. 6 shows the cross-section (A-A) which produces high lift in the tail.

FIG. 7 shows a fuselage variant with their curved upper (4) and lower (5) surfaces.

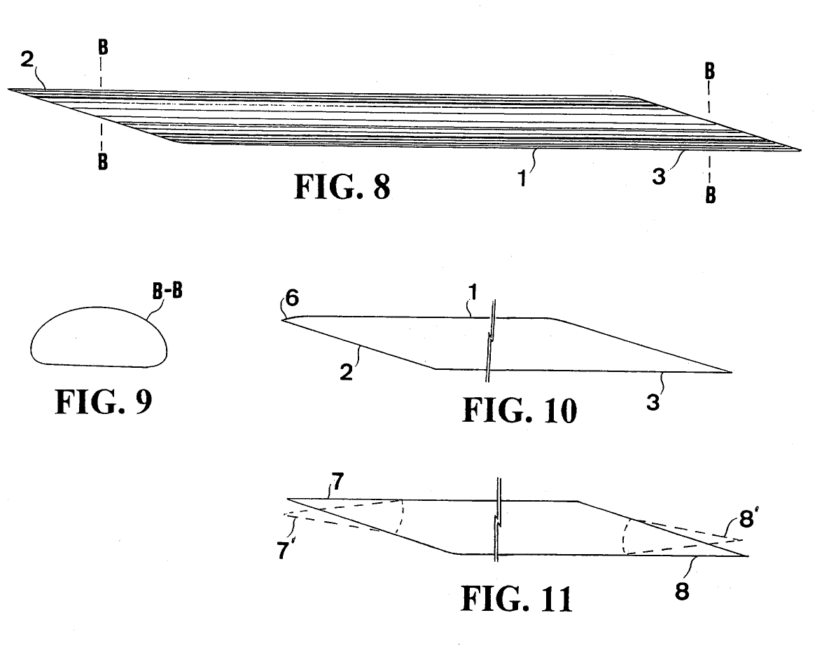

FIG. 8 shows the central fuselage (1), the cylindrical nose with an inclined cut or truncated (2), the cylindrical tail with an inclined cut or truncated (3) and the cross-sections of the same (B-B).

FIG. 9 shows the cross-section (B-B) which produces the highest lift in the nose and in the tail, in the tail this cross-section must be the one used in this figure but inverted.

FIG. 10 shows the central fuselage (1), the nose (2) with a small portion of the same (6) slightly inclined downwards, and the tail (3).

FIG. 11 shows the rotating or swing nose (7 and 7′) and the rotating or swing tail (8 and 8′).

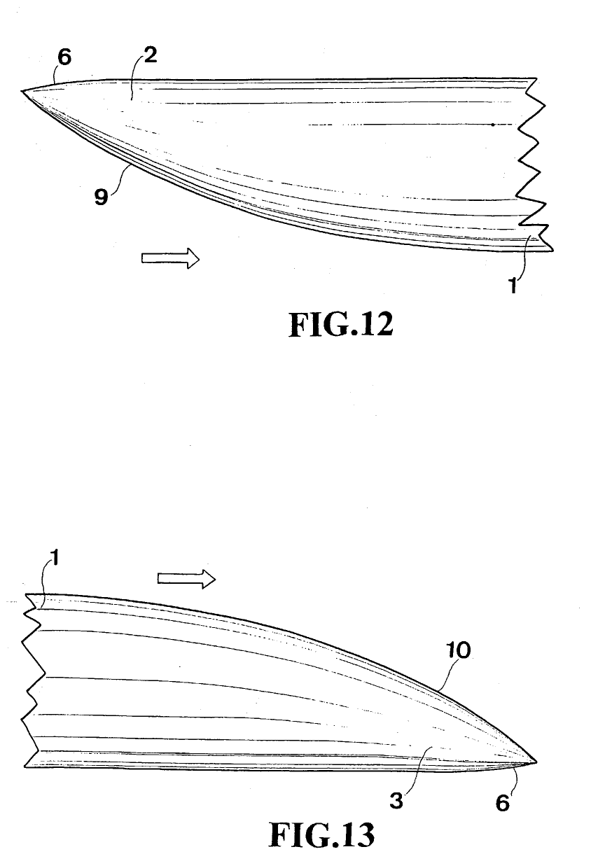

FIG. 12 shows the central fuselage (1), the nose (2) with a small portion or tip of the same (6) slightly curved downwards and its convex surface (9).

FIG. 13 shows the central fuselage (1), the tail (3) with a small portion or tip of the same (6) slightly curved upwards and its convex surface (10).

What is claimed is:

1. An aircraft fuselage lift arrangement comprising:
an elongated vertically flattened oval central cross section fuselage having a first longitudinal axis;
an upper second longitudinal axis along an uppermost portion of said fuselage parallel to said longitudinal axis;
a lower third longitudinal axis parallel to said first longitudinal axis, along the length of the bottom of said fuselage;
said fuselage having a conical nose portion at one end and a conical tail portion at its opposite end;
said nose portion of said fuselage having an upwardly inclined front wall extending upwardly from said bottom portion to at least said upper second longitudinal axis; and
said tail portion of said fuselage having a downwardly declining rear wall extending from said upper second longitudinal axis to said bottom portion of said fuselage;
said nose and tail portions having a vertical flattened oval cross-section; and
said fuselage having a main landing gear.

2. An aircraft fuselage lift arrangement according to claim 1 wherein two oblique cones are used at said nose and tail linked around their bases to said fuselage and inclined so that their more external generatrixes of said cones are in line with and form a continuation of said upper and lower longitudinal axis of said fuselage and whose cross-section is oval, vertically flattened.

3. An aircraft fuselage lift arrangement according to claim 1 wherein two oblique cones are used at said nose and tail linked around their bases to said fuselage and inclined so that their more external generatrixes of said cones are in line with and form a continuation of said upper and lower longitudinal axis of said fuselage and whose cross-section is oval laterally flattened.

4. An aircraft fuselage lift arrangement according to claim 1 wherein said fuselage adopts a curved or semicircular upper surface and a lower one flattened with rounded linkage.

5. An aircraft fuselage lift arrangement according to claim 1 wherein said fuselage adopts a flattened upper surface and a lower one curved or semicircular with rounded linkage.

6. An aircraft fuselage lift arrangement according to claim 1 wherein said fuselage adopts a cross-section equal to said nose or tail base.

7. An aircraft fuselage lift arrangement according to claim 1 wherein said fuselage adopts a cross-section different to said nose and tail, and are joined or linked by means of a smooth streamlined union or joint.

8. An aircraft fuselage lift arrangement according to claim 1 wherein said fuselage is slightly curved lengthways with its concavity in the bottom.

9. An aircraft fuselage lift arrangement according to claim 1 wherein a small portion of said nose and tail tips are slightly curved downwards and upwards respectively and said nose lower surface and said tail upper surface are slightly curved or convex respectively, for both conic and flat noses or tails.

10. An aircraft fuselage lift arrangement according to claim 1 wherein said nose and the tail or a portion of the same are rotary or swinging at their bases and around an axis parallel to the transversal aircraft axis.

11. An aircraft fuselage lift arrangement according to claim 1 wherein said main landing gear is set backwards and is higher.

12. An aircraft fuselage lift arrangement comprising:
an elongated vertically flattened central cross section fuselage having a first longitudinal axis;
an upper second longitudinal axis along an uppermost portion of said fuselage parallel to said longitudinal axis;
a lower third longitudinal axis parallel to said first longitudinal axis, along the length of the bottom of said fuselage;
said fuselage having a conical nose portion at one end and a conical tail portion at its opposite end;
said nose portion of said fuselage having an upwardly inclined front wall extending upwardly from said bottom portion to at least said upper second longitudinal axis; and
said tail portion of said fuselage having a downwardly declining rear wall extending from said upper second longitudinal axis to said bottom portion of said fuselage;
the whole fuselage, the conical nose, the conical tail and the central fuselage adopt a curved or semicircular upper surface and a lower one flattened with the linkage rounded.

13. An aircraft fuselage lift arrangement according to claims 1 or 12, wherein said nose and tail or a portion of the same are rotary or swinging at their bases and around an axis parallel to the transversal aircraft axis.
